(19) United States
(12) Patent Application Publication
(10) Pub. No.: US 2020/0301423 A1
(43) Pub. Date: Sep. 24, 2020

(54) FLIGHT CONTROL METHOD FOR AGRICULTURAL UNMANNED AERIAL VEHICLE, RADAR SYSTEM, AND AGRICULTURAL UNMANNED AERIAL VEHICLE

(71) Applicant: SZ DJI TECHNOLOGY CO., LTD., Shenzhen (CN)

(72) Inventors: Junxi WANG, Shenzhen (CN); Chunming WANG, Shenzhen (CN); Xumin WU, Shenzhen (CN); Renli SHI, Shenzhen (CN)

(21) Appl. No.: 16/891,784

(22) Filed: Jun. 3, 2020

Related U.S. Application Data
(63) Continuation of application No. PCT/CN2017/116858, filed on Dec. 18, 2017.

(51) Int. Cl. G05D 1/00; G05D 1/06; G01S 13/91

(52) U.S. Cl. CPC G05D 1/0088; G05D 1/0676; B64C 2201/18; B64C 2201/141; G01S 13/913

(57) ABSTRACT

A flight control method of an agricultural unmanned aerial vehicle (UAV) includes controlling a rotation device to rotate continuously to drive a radar detection device to rotate continuously, obtaining detection information at a plurality of rotation directions during continuous rotation of the radar detection device, and controlling take-off and landing of the agricultural UAV according to the detection information.

### CROSS-REFERENCE TO RELATED APPLICATION

This application is a continuation of International Application No. PCT/CN2017/116858, filed Dec. 18, 2017, the entire content of which is incorporated herein by reference.

### TECHNICAL FIELD

The present disclosure relates to the unmanned aerial vehicle (UAV) field and, more particularly, to a flight control method for an agricultural UAV, a radar system, and an agricultural UAV.

### BACKGROUND

An agricultural unmanned aerial vehicle (UAV) can take off and land automatically. The agricultural UAV can also perform spraying operation on agricultural and forestry plants. The agricultural UAV usually carries a detection device to detect a relative height and a relative velocity of the agricultural UAV relative to ground or an obstacle. The detection device is further configured for automatic take-off and landing of the agricultural UAV.

The detection device carried by the agricultural UAV usually includes an ultrasonic sensor and a vision sensor. The ultrasonic sensor can easily be interfered by noise of rotors of the agricultural UAV and the detection distance is short. The vision sensor has strict requirements for an environment. When the agricultural UAV is in a harsh operation environment, detection of the vision sensor is limited.

Therefore, methods of the existing technology are not suitable for the operation environment of the agricultural UAV and cannot satisfy operation needs of the agricultural UAV.

### SUMMARY

Embodiments of the present disclosure provide a flight control method of an agricultural unmanned aerial vehicle (UAV). The method includes controlling a rotation device to rotate continuously to drive a radar detection device to rotate continuously, obtaining detection information at a plurality of rotation directions of continuous rotation during the radar detection device, and controlling take-off and landing of the agricultural UAV according to the detection information.

Embodiments of the present disclosure provide an agricultural unmanned aerial vehicle (UAV) including a body, a power system, a radar system, and a flight controller. The power system is mounted at the body and configured to provide flight power. The radar system includes a radar detection device and a rotation device. The rotation device is arranged at the body. The rotation device carries the radar detection device. The flight controller is communicatively connected to the power system and configured to control flight of the agricultural UAV. The flight controller is configured to control the rotation device to rotate continuously to drive the radar detection device to rotate continuously, obtain detection information at a plurality of rotation directions during continuous rotation of the radar detection device, and control take-off or landing of the agricultural UAV according to the detection information.

Embodiments of the present disclosure provide a computer-readable non-transitory storage medium including instructions, which when executed on a computer, cause the computer to control a rotation device to rotate continuously to drive a radar detection device to rotate continuously, obtain detection information at a plurality of rotation directions during continuous rotation of the radar detection device, and control take-off or landing of the agricultural UAV according to the detection information.

### BRIEF DESCRIPTION OF THE DRAWINGS

FIG. 1 illustrates a schematic structural diagram of an agricultural unmanned aerial vehicle (UAV) including a radar system according to some embodiments of the present disclosure.

FIG. 2 illustrates another schematic structural diagram of the agricultural UAV including the radar system according to some embodiments of the present disclosure.

FIG. 3 illustrates a flowchart of a flight control method of the agricultural UAV according to some embodiments of the present disclosure.

FIG. 4 illustrates a flowchart of a flight control method of the agricultural UAV according to some embodiments of the present disclosure.

FIG. 5 illustrates a diagram schematically showing detection by a radar detection device at three rotation directions.

FIG. 6 illustrates a flowchart of a flight control method of the agricultural UAV according to some embodiments of the present disclosure.

FIG. 7 illustrates a schematic structural diagram of the agricultural UAV according to some embodiments of the present disclosure.

Reference numerals:

| | | |
|---|---|---|
| 11-radar system | 12-radar detection device | 13-rotation device |
| 121-control circuit board | 122-first radio frequency antenna | 123-second radio frequency |
| | | antenna |
| 131-rotation platform | 132-electronic speed control board | 133-interface board |
| 1200-UAV | 1207-electric motor | 1206-propeller |
| 1217-electronic speed controller | 1218-flight controller | 1208-radar system |
| 1210-communication system | 1202-support device | 1204-photographing device |
| 1212-ground station | 1214-antenna | 1216-electromagnetic wave |

### DETAILED DESCRIPTION OF THE EMBODIMENTS

To make purposes, technical solutions, and advantages of the present disclosure clearer, the technical solutions in embodiments of the present disclosure are described in conjunction with accompanying drawings in embodiments of the present disclosure. The described embodiments are only some embodiments not all the embodiments of the present disclosure. Based on the embodiments of the disclosure, all other embodiments obtained by those of ordinary skill in the art without any creative work are within the scope of the present disclosure.

The term “and/or” referred to in the present specification describes an association relationship between associated objects and indicates three kinds of relationships. For example, A and/or B can represent three situations that A exists alone, both A and B exist, and B exists alone. The symbol “/” generally indicates that the associated objects have an “or” relationship.

In following embodiments of the present disclosure, an agricultural unmanned aerial vehicle (UAV) is taken as an example to describe the technical solutions of the present disclosure. However, the technical solutions of the present disclosure are not only suitable for the agricultural UAV, but also may be suitable for other types of UAVs.

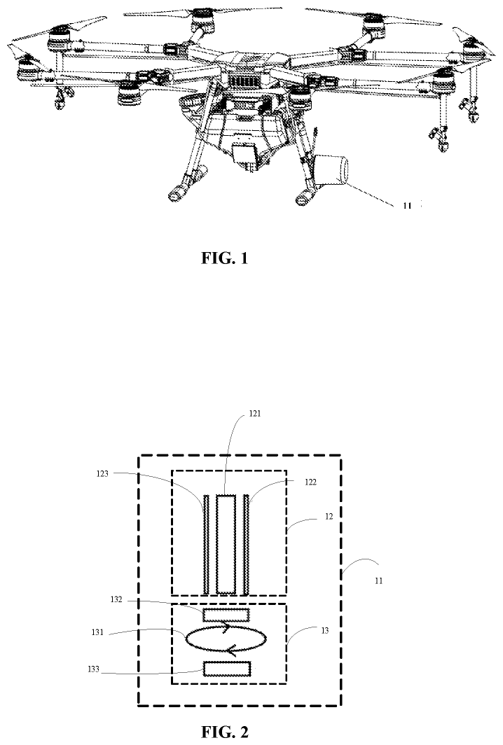

FIG. 1 illustrates a schematic structural diagram of an agricultural UAV including a radar system according to some embodiments of the present disclosure. FIG. 2 illustrates another schematic structural diagram of the agricultural UAV including the radar system according to some embodiments of the present disclosure. As shown in FIG. 1 and FIG. 2, the agricultural UAV includes a radar system 11. The radar system 11 includes a radar detection device 12 and a rotation device 13. The rotation device 13 is placed at the body of the agricultural UAV. The rotation device 13 carries the radar detection device 12.

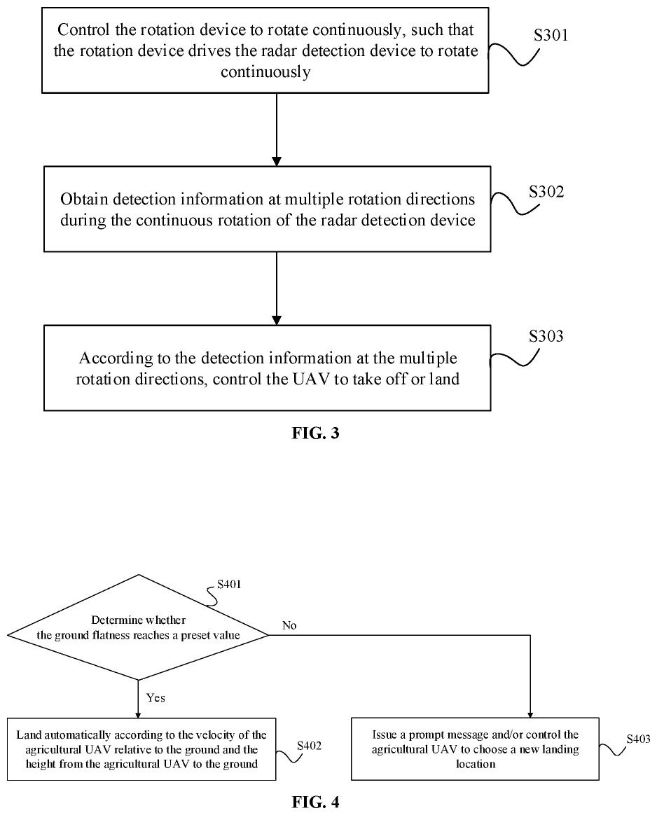

FIG. 3 illustrates a flowchart of a flight control method of the agricultural UAV according to some embodiments of the present disclosure. The method may be implemented, e.g., by a flight controller of the agricultural UAV, or by another general-purpose or special-purpose processor, which are all referred to as the agricultural UAV in the disclosure. As shown in FIG. 3, the method includes following processes.

At S301, the agricultural UAV controls the rotation device to rotate continuously, such that the rotation device drives the radar detection device to rotate continuously.

At S302, the agricultural UAV obtains detection information at multiple rotation directions during the continuous rotation of the radar detection device.

As shown in FIG. 1 and FIG. 2, the flight controller of the agricultural UAV can control the rotation device 13 to rotate continuously. The rotation device 13, when rotating continuously, can drive the radar detection device 12 carried by the rotation device 13 to rotate continuously. Thus, the flight controller can obtain the detection information at the multiple rotation directions.

In some embodiments, the rotation device 13 may rotate for 360°, that is, the radar detection device 12 may obtain detection information within 360° around the agricultural UAV.

In some embodiments, the detection information at the multiple rotation directions obtained by the agricultural UAV may include at least one of a relative distance from the agricultural UAV to a target object, a velocity of the agricultural UAV relative to the ground, a height from the agricultural UAV to the ground, or ground flatness information.

The target object is an obstacle surrounding the body of the agricultural UAV.

At S303, according to the detection information at the multiple rotation directions, the flight controller controls the UAV to take off or land.

After the agricultural UAV obtains the detection information of the radar detection device at the multiple rotation directions, the UAV can automatically take off or land based on the detection information.

In some embodiments, the radar system is arranged at the agricultural UAV, and the radar system includes the rotation device and the radar detection device carried by the rotation device. When the rotation device rotates continuously, the radar detection device rotates correspondingly to obtain the detection information at the multiple rotation directions. Based on the detection information, the agricultural UAV realizes the automatic take-off or landing. Compared to the method of the existing technology, embodiments of the present disclosure use the rotatable radar system to obtain the detection information at the multiple rotation directions. Therefore, the method has a stronger adaptability to the environment, and the detection information is more accurate, which can satisfy operation needs of the agricultural UAV.

A process of take-off or landing of the agricultural UAV according to the obtained detection information is described in detail below.

In some embodiments, the agricultural UAV can automatically take off and ascend to a preset height for operation according to the detection information.

In some embodiments, according to the detected velocity of the agricultural UAV relative to the ground and the height from the agricultural UAV to the ground, the agricultural UAV can determine whether the agricultural UAV can take off and ascend to the preset height, and at which velocity the agricultural UAV takes off.

In some embodiments, the agricultural UAV can automatically land according to the detection information.

FIG. 4 illustrates a flowchart of a flight control method of the agricultural UAV according to some embodiments of the present disclosure. As shown in FIG. 4, a method for the agricultural UAV to automatically land according to the detection information includes following processes.

At S401, the agricultural UAV determines whether the ground flatness reaches a preset value, if yes, execute S402, and if no, execute S403.

In some embodiments, the ground flatness is obtained and calculated according to heights at multiple locations from the agricultural UAV to the ground detected by the radar detection device.

In some embodiments, the radar detection device 12 is horizontally mounted under the agricultural UAV body through the rotation device 13. A rotation axis of the radar detection device 12 is parallel to the pitch axis of the agricultural UAV.

Further, the radar detection device 12 can detect information at the multiple rotation directions.

The multiple rotation directions at least include a vertical direction, a forward inclined direction inclined forward by a first preset angle, and a backward inclined direction inclined backward by a second preset angle.

For example, the first preset angle and the second present angle are 45°.

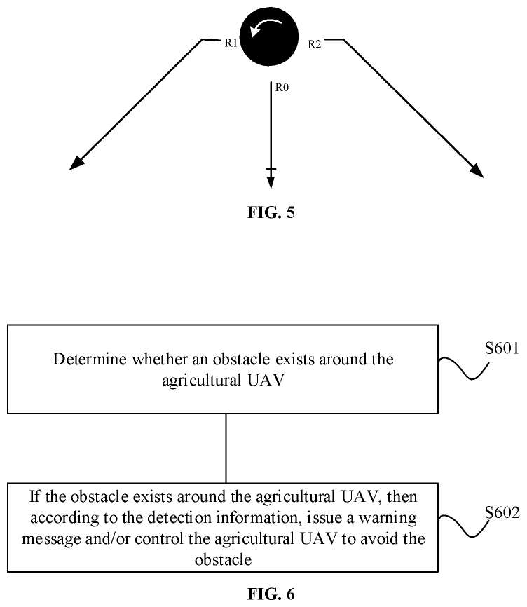

FIG. 5 illustrates a diagram schematically showing detection by a radar detection device at three rotation directions. As shown in FIG. 5, the radar detection device detects distances from the agricultural UAV to the ground at the vertical direction R0, the forward inclined direction R1 inclined forward by 45°, and the backward inclined direction R2 inclined backward by 45°. Assume the detected values are HO, H1, and H2. The three values represent the distances from the agricultural UAV to three different locations on the ground, respectively.

The agricultural UAV can obtain ground flatness information by comparing the detected H0, H1, and H2 detected at the three directions. The ground flatness information, for example, may be represented by different levels. For example, if differences between each two of H0, H1, and H2 are all smaller than a first preset value, the ground flatness reaches a first level. If the differences between each two of H0, H1, and H2 are all smaller than a second preset value, the ground flatness reaches a second level. When the ground flatness reaches a preset value (e.g., a first level), the agricultural UAV determines that the ground flatness satisfies requirements and can continue to execute S402, otherwise execute S403.

At S402, the agricultural UAV automatically lands according to the velocity of the agricultural UAV relative to the ground and the height from the agricultural UAV to the ground.

In some embodiments, the agricultural UAV determines that the ground flatness information satisfies the requirements. According to the detected velocity of the agricultural UAV relative to the ground and the height from the agricultural UAV to the ground, the agricultural UAV can determine at what velocity the agricultural UAV lands.

At S403, the agricultural UAV issues a prompt message and/or controls the agricultural UAV to choose a new landing location.

In some embodiments, if the ground flatness information does not satisfy the requirements, the present ground is not suitable for landing. The agricultural UAV can issue a prompt message to prompt the user to re-select the landing location, can automatically re-select a new landing location, or can issue a prompt message and re-select a new landing location at the same time.

In some embodiments, the above prompt message is issued by the agricultural UAV, or the above prompt message is transmitted to a remote controller by the agricultural UAV and then issued by the remote controller.

For example, when the agricultural UAV issues directly the prompt message, the agricultural UAV can control a status light carried by the agricultural UAV to issue prompt light. The agricultural UAV can also control a speaker carried by the agricultural UAV to issue a prompt sound. When the agricultural UAV issues the prompt message to the remote controller, a display screen of the remote controller can display the prompt message, an indication light of the remote controller can issue the prompt light, the remote controller can vibrate to prompt the user, etc.

In the embodiments, the agricultural UAV can obtain the ground flatness information by detecting the heights from the agricultural UAV to the ground at multiple locations. According to the ground flatness information, the agricultural UAV can automatically land or re-select a landing location to ensure a safer landing of the agricultural UAV. The existing technology usually uses a single sensor, which can only obtain height information vertically below the agricultural UAV. Therefore, the single sensor cannot obtain the ground flatness information. Compared to the existing technology, the method according to embodiments of the disclosure can significantly improve safety during landing of the agricultural UAV.

In some embodiments, the agricultural UAV can avoid the obstacles during taking off or landing according to the detection information.

FIG. 6 illustrates a flowchart of a flight control method of the agricultural UAV according to some embodiments of the present disclosure. As shown in FIG. 6, a process of the agricultural UAV to avoid the obstacles during taking off or landing according to the detection information includes following processes.

At S601, the agricultural UAV determines whether an obstacle exists around the agricultural UAV.

At S602, if the obstacle exists around the agricultural UAV, then according to the detection information, the agricultural UAV issues a warning message and/or controls the agricultural UAV to avoid the obstacle.

When the radar detection device 12 detects information at multiple rotation directions, the radar detection device 12 can detect whether the obstacle exist around the agricultural UAV. The radar detection device 12 can also detect a distance, a velocity, a direction, a height, etc., of the agricultural UAV relative to the obstacle.

When the obstacle exists around the agricultural UAV, the agricultural UAV can issue a warning message and/or control the agricultural UAV to avoid the obstacle.

In some embodiments, the agricultural UAV can issue the warning message, control the agricultural UAV to avoid the obstacle, or issue the warning message and control the agricultural UAV to avoid the obstacle at the same time.

For example, when the distance of the agricultural UAV relative to the obstacle is larger than a preset first threshold and the velocity is smaller than a preset second threshold, i.e., when the agricultural UAV is relatively far from the obstacle and the relative velocity is relatively small, the agricultural UAV can just issue the warning message. When the distance of the agricultural UAV relative to the obstacle is smaller than a preset third threshold and the velocity is larger than a preset fourth threshold, i.e., when the agricultural UAV is relatively close to the obstacle and the relative velocity is relatively large, the agricultural UAV can issue the warning message and control the agricultural UAV to avoid the obstacle.

In some embodiments, the warning message can be issued by the agricultural UAV, or can also be transmitted to the remote controller by the agricultural UAV and then issued by the remote controller.

For example, when the agricultural UAV directly issues the warning message, the agricultural UAV can control the status light carried by the agricultural UAV to issue a warning light, or control the speaker carried by the agricultural UAV to issue a warning sound. When the agricultural UAV transmits the warning message to the remote controller, the display screen of the remote controller can display the warning message, the indication lights can issue the warning light, the remote controller can vibrate to prompt the warning, etc.

In some embodiments, according to the detection information of the radar detection device, the agricultural UAV controls the UAV to avoid the obstacle to improve the flight safety of the UAV.

As shown in FIG. 2, the radar detection device 12 includes a control circuit board 121 and at least one radio frequency antenna. The control circuit board 121 is electrically connected to the at least one radio frequency antenna. In some embodiments, the radar detection device 12 includes the control circuit board 121, a first radio frequency antenna 122, and a second radio frequency antenna 123. The control circuit board 121 is located between the first radio frequency antenna 122 and the second radio frequency antenna 123.

As shown in FIG. 1, a board surface of the control circuit board 121 is parallel to a board surface of the first radio frequency antenna 122, and the board surface of the control circuit board 121 is parallel to a board surface of the second radio frequency antenna 123.

In some embodiments, an angle between the board surface of the radio frequency antenna and the board surface of the control circuit board is a preset angle.

In addition, as shown in FIG. 2, the rotation device 13 includes a rotation platform 131, an electronic speed control board 132, and an interface board 133. The rotation platform 131 is configured to carry the radar detection device. The electronic speed control board 132 is electrically connected to an electric motor, is configured to drive the electric motor to rotate, and control a rotation status of the electric motor. The electric motor is configured to drive the rotation platform to rotate. The interface board 133 is electrically connected to the electronic speed control board 132 and/or the detection device. The interface board 133 is configured to electrically connect to external circuits.

In some embodiments, the agricultural UAV first controls the first radio frequency antenna 122 to transmit electromagnetic waves to surroundings through the control circuit board 121 and receives echo waves through the second radio frequency antenna 123. The agricultural UAV further mixes the received echo waves to obtain an intermediate frequency signal. The agricultural UAV further performs an analog-to-digital conversion for the intermediate frequency signal to obtain a digital signal. The agricultural UAV further performs a signal analysis to the digital signal to obtain the detection information.

In some embodiments, the radar detection device 12 detects the target object around the agricultural UAV through digital beam forming (DBF).

Embodiments of the present disclosure provide a radar system. As shown in FIG. 1 and FIG. 2, the radar system 11 includes the radar detection device 12 and the rotation device 13. The rotation device is arranged at the agricultural UAV body. The rotation device 13 carries the radar detection device 12. The rotation device 13 drives the radar detection device 12 to rotate continuously. When the rotation device 13 drives the radar detection device 12 to rotate continuously, the radar detection device obtains the detection information.

In some embodiments, the detection information includes at least one of the distance, the velocity, the direction, or the height of the agricultural UAV relative to the target object, the velocity of the agricultural UAV relative to the ground, the height from the agricultural UAV to the ground, or the ground flatness information. The target object is an obstacle around the agricultural UAV body.

In some embodiments, the multiple rotation directions at least include the vertical direction, the forward inclined direction inclined forward by the first preset angle, and the backward inclined direction inclined backward by the second preset angle.

In some embodiments, the radar detection device is mounted horizontally under the agricultural UAV body through the rotation device.

The rotation axis of the radar detection device is parallel to the pitch axis of the agricultural UAV.

In some embodiments, the radar detection device includes the control circuit board and the at least one radio frequency antenna. The control circuit board is electrically connected to the at least one radio frequency antenna.

In some embodiments, the angle between the board surface of the radio frequency antenna and the board surface of the control circuit board is the preset angle.

In some embodiments, the radar detection device includes the control circuit board, the first radio frequency antenna, and the second radio frequency antenna. The control circuit board is located between the first radio frequency antenna and the second radio frequency antenna.

In some embodiments, the rotation device includes the rotation platform, the electronic speed control board, and the interface board. The platform is configured to carry the radar detection device. The electronic speed control board is electrically connected to the electric motor, and is configured to drive the electric motor to rotate and control the rotation status of the electric motor. The electric motor is configured to drive the rotation platform to rotate. The interface board is electrically connected to the electronic speed control board and/or the detection device. The interface board is configured to electrically connect to the external wires.

In some embodiments, the radar detection device detects the target object around the agricultural UAV through the DBF.

In the embodiments, the agricultural UAV controls the rotation device of the radar system to cause the rotation device to rotate continuously. The rotation device, when rotating continuously, drives the radar detection device of the radar system to rotate continuously. The agricultural UAV controls the take-off or landing of the UAV according to the detection information obtained during the continuous rotation of the radar detection device. The radar system has a stronger adaptability to the environment. The detected information is more accurate. The radar system can satisfy the operation requirements of the agricultural UAV.

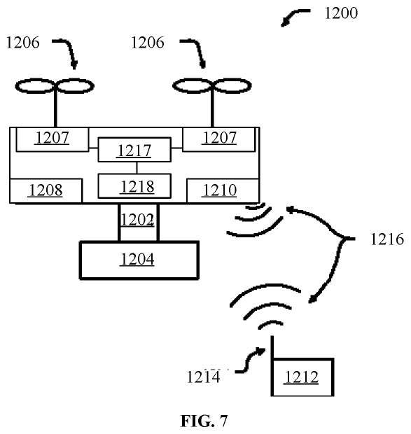

Embodiments of the present disclosure also provide an agricultural UAV. FIG. 7 illustrates a schematic structural diagram of the agricultural UAV according to some embodiments of the present disclosure. As shown in FIG. 7, the agricultural UAV 1200 includes a body, a power system, a flight controller 1218, and a radar system 1208. The power system includes at least one of an electric motor 1207, a propeller 1206, or an electronic speed controller 1217. The power system is mounted at the body and is configured to provide flight power. The flight controller 1218 is communicatively connected to the power system and is configured to control the flight of the UAV.

Principles and implementations of the radar system 1208 are similar to the above embodiments, which are not repeated here.

Principles and implementations of the flight controller 1218 are similar as the above embodiments, which are not repeated here.

In addition, as shown in FIG. 7, the agricultural UAV 1200 further includes a communication system 1210, a support device 1202, and a photographing device 1204. The support device 1202 may be a gimbal. The communication system 1210 may include a receiver. The receiver is configured to receive a wireless signal transmitted by the antenna 1214 of a ground station 1212. 1216 represents electromagnetic waves generated during a communication process of the receiver and the antenna 1214.

In some embodiments, the agricultural UAV controls the rotation device of the radar system to rotate continuously. The rotation device, when rotating continuously, drives the radar detection device of the radar system to rotate continuously. According to the detection information during the continuous rotation of the radar detection device, the agricultural UAV controls the take-off or landing of the UAV. The radar system has a stronger adaptability to the environment. The detection information is more accurate. The radar system can satisfy the operation requirements of the agricultural UAV.

In some embodiments of the disclosure, the devices and methods disclosed can be implemented in other forms. For example, the device embodiments described above are merely illustrative. For example, the division of the units is only a logical function division, and the actual implementation may be according to another division method. For example, a plurality of units or components can be combined or integrated in another system, or some features can be omitted or not be executed. Further, the displayed or discussed mutual coupling or direct coupling or communicative connection can be through some interfaces, the indirect coupling or communicative connection of the devices or units can be electronically, mechanically, or in other forms.

The units described as separate components may be or may not be physically separated, the components displayed as units may be or may not be physical units, which can be in one place or be distributed to a plurality of network units. Some or all of the units can be chosen to implement the purpose of the embodiment according to the actual needs.

In the embodiment of the disclosure, individual functional units can be integrated in one processing unit, or can be individual units physically separated, or two or more units can be integrated in one unit. The integrated units above can be implemented by hardware or can be implemented by hardware and software functional units.

The integrated units implemented by software functional units can be stored in a computer-readable storage medium. The above software functional units stored in a storage medium includes a plurality of instructions for a computing device (such as a personal computer, a server, or network device, etc.) or a processor to execute some of the operations in the embodiments of the disclosure. The storage medium includes USB drive, mobile hard disk, read-only memory (ROM), random access memory (RAM), disk or optical disk, or another medium that can store program codes.

Those skilled in the art can understand that, for convenient and simple description, the division of individual functional modules are described as an example. In actual applications, the functions above can be assigned to different functional modules for implementation, i.e., the internal structure of the device can be divided into different functional modules to implement all or some of the functions described above. For the specific operation process of the device described above, reference can be to the corresponding process in the method embodiments, which is not be described in detail here.

The embodiments are merely used to describe the technical solutions of the disclosure but not used to limit the disclosure. Although the disclosure is described in detail with reference to the individual embodiments, one of ordinary skill in the art should understand that it is still possible to modify the technical solutions in the embodiments, or to replace some or all of the technical features. However, these modifications or substitutions do not cause the essence of the corresponding technical solution to depart from the scope of the technical solutions in the individual embodiments of the disclosure.

What is claimed is:

1. A flight control method of an agricultural unmanned aerial vehicle (UAV) comprising:
controlling a rotation device to rotate continuously to drive a radar detection device to rotate continuously;
obtaining detection information at a plurality of rotation directions during continuous rotation of the radar detection device; and
controlling take-off or landing of the agricultural UAV according to the detection information.

2. The method of claim 1, wherein the detection information includes at least one of a distance, a velocity, a direction, or a height of the agricultural UAV relative to a target object, a velocity of the agricultural UAV relative to ground, a height from the agricultural UAV to the ground, or a ground flatness.

3. The method of claim 2, wherein controlling the take-off or landing of the agricultural UAV according to the detection information includes controlling the agricultural UAV to take off automatically and ascend to a preset height for operation according to the detection information.

4. The method of claim 2, wherein controlling the take-off or landing of the agricultural UAV according to the detection information includes controlling the agricultural UAV to land automatically according to the detection information.

5. The method of claim 4, wherein controlling the agricultural UAV to land automatically according to the detection information includes:
determining whether the ground flatness reaches a preset value;
in response to the ground flatness reaching the preset value, controlling the agricultural UAV to land automatically according to the velocity of the agricultural UAV relative to the ground and the height from the agricultural UAV to the ground; and
in response to the ground flatness not reaching the preset value, performing at least one of issuing a prompt message or controlling the agricultural UAV to re-select a landing location.

6. The method of claim 5, wherein issuing the prompt message includes:
controlling the agricultural UAV to issue the prompt message directly, or
transmitting the prompt message to a remote controller for the remote controller to issue the prompt message.

7. The method of claim 2, wherein controlling the take-off or landing of the agricultural UAV according to the detection information includes controlling the agricultural UAV to avoid an obstacle during the take-off or landing according to the detection information.

8. The method of claim 7, wherein controlling the agricultural UAV to avoid the obstacle during the take-off or landing according to the detection information includes:
determining whether the obstacle exists around the agricultural UAV according to the detection information; and
in response to the obstacle existing around the agricultural UAV, performing at least one of issuing a warning message or controlling the agricultural UAV to avoid the obstacle.

9. The method of claim 8, wherein issuing the warning message includes:
controlling the agricultural UAV to issue the warning message directly, or
transmitting the warning message to a remote controller for the remote controller to issue the warning message.

10. The method of claim 1, wherein the multiple rotation directions include a vertical direction, a forward inclined direction inclined forward by a first preset angle, and a backward inclined direction inclined backward by a second preset angle.

11. The method of claim 1, wherein:
the radar detection device is mounted horizontally under a body of the agricultural UAV through the rotation device; and
a rotation axis of the radar detection device is parallel to a pitch axis of the agricultural UAV.

12. The method of claim 1, wherein the radar detection device includes a control circuit board and a radio frequency antenna electrically connected to the control circuit board.

13. The method of claim 12, wherein an angle between a board surface of the radio frequency antenna and a board surface of the control circuit board is a preset angle.

14. The method of claim 1, wherein the radar detection device includes a control circuit board, a first radio frequency antenna, and a second radio frequency antenna, the control circuit board being located between the first radio frequency antenna and the second radio frequency antenna.

15. The method of claim 14, wherein obtaining the detection information at the plurality of rotation directions during the continuous rotation of the radar detection device includes:
controlling, through the control circuit board, the first radio frequency antenna to transmit electromagnetic waves to surrounds;
receiving echo waves through the second radio frequency antenna;
mixing the echo waves to obtain an intermediate frequency signal;
performing an analog-to-digital conversion on the intermediate frequency signal to obtain a digital signal; and
performing a signal analysis on the digital signal to obtain the detection information.

16. The method of claim 1, wherein the rotation device includes:
a rotation platform configured to carry the radar detection device;
an electric motor configured to drive the rotation platform to rotate;
an electronic speed control board electrically connected to the electric motor and configured to drive the electric motor and control a rotation status of the electric motor; and
an interface board electrically connected to at least one of the electronic speed control board or the detection device and configured to electrically connect to an external circuit.

17. The method of claim 1, wherein the radar detection device is configured to detect a target object around the agricultural UAV through digital beam forming (DBF).

18. An agricultural unmanned aerial vehicle (UAV) comprising:
a body;
a power system mounted at the body and configured to provide flight power;
a radar system including a radar detection device and a rotation device, the rotation device being arranged at the body, the rotation device carrying the radar detection device; and
a flight controller communicatively connected to the power system and configured to control flight of the agricultural UAV, the flight controller being configured to:
control the rotation device to rotate continuously to drive the radar detection device to rotate continuously;
obtain detection information at a plurality of rotation directions during continuous rotation of the radar detection device; and
control take-off or landing of the agricultural UAV according to the detection information.

19. A computer-readable non-transitory storage medium including instructions, which when executed on a computer, cause the computer to:
control a rotation device to rotate continuously to drive a radar detection device to rotate continuously;
obtain detection information at a plurality of rotation directions during continuous rotation of the radar detection device; and
control take-off or landing of the agricultural UAV according to the detection information.
